(19) United States
(12) Patent Application Publication
(10) Pub. No.: US 2008/0038004 A1
(43) Pub. Date: Feb. 14, 2008

(54) IMAGE FORMING APPARATUS

(75) Inventor: Hiroshige Inoue, Abiko-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/832,345

(22) Filed: Aug. 1, 2007

(30) Foreign Application Priority Data
Aug. 11, 2006 (JP) 2006-220635
May 31, 2007 (JP) 2007-146107

(51) Int. Cl. G03G 15/00

(52) U.S. Cl. 399/45; 399/301

(57) ABSTRACT

An apparatus includes a position detection sensor arranged so as to detect the leading end of a sheet and a toner image formed on an intermediate transfer belt. The position detection sensor is constructed as a single component configured to detect the position of a sheet and that of a position indication pattern on the transfer belt. The positional discrepancy between the sheet and the image is corrected based on the detection by the position detection sensor.

### BACKGROUND OF THE INVENTION

1. Field of the Invention

The present invention relates to an image forming apparatus such as a copying machine or printer and, more particularly, to an image forming apparatus which increases the positional precision of an image on a sheet by using a sensor arrangement on a pre-transfer conveying path.

2. Description of the Related Art

FIG. 17 is a sectional view showing the schematic structure of a conventional copying machine and printer. The image forming section comprises a yellow station 90, magenta station 96, cyan station 97, and black station 98. A toner image formed on the drum of each station is transferred onto an intermediate transfer belt 40 by a transfer roller 45. The intermediate transfer belt 40 is suspended by a driving roller 42, steering roller 41, and secondary transfer roller 43. The driving roller 42 drives the belt. The steering roller 41 controls the movement of the belt, and applies tension. The secondary transfer roller 43 transfers, to a sheet, multiple toner images transferred on the intermediate transfer belt 40.

A secondary outer transfer roller 44 is arranged to face the secondary transfer roller 43. A paper feed deck 10 on which sheets S are stacked and stored, a sheet conveying unit 20, and a registration unit 30 are arranged below the image forming section.

A pair of conveying rollers 21 before registration rollers is arranged in the sheet conveying unit 20. A pair of registration rollers 31 is arranged in the registration unit 30. A sheet guide for guiding a conveyed sheet is interposed between the pair of pre-registration rollers 21 and the pair of registration rollers 31.

Sheets S fed one by one from the paper feed deck 10 are supplied to the registration unit 30 via the sheet conveying unit 20. In the registration unit 30, each sheet S conveyed by the pair of pre-registration rollers 21 forms a loop by pressing the leading end of the sheet S against the press-contact portion (nip portion) of the pair of registration rollers 31 at rest. The leading end of the pressed sheet S aligns with the nip line of the pair of registration rollers 31, correcting the skew of the sheet S. The skew-corrected sheet S is conveyed to the pair of secondary transfer rollers 43 and 44 by the pair of registration rollers 31 driven in sync with the image write timing such that the leading end of the sheet aligns with that of a toner image.

The pair of secondary transfer rollers 43 and 44 transfers a toner image on the intermediate transfer belt 40 onto the sheet S. The sheet S bearing the toner image is guided to a fixing device 50 by a conveyance belt 51. When the sheet S passes through a fixing roller and pressing roller, heat and pressure are applied to fuse the toner image onto the sheet S. The sheet S having undergone the fixing process is discharged outside the apparatus via a delivery unit 60.

A patch sensor 47 for detecting the leading end positions of multiple transferred toner images is arranged upstream of the secondary transfer roller 43. A sheet sensor 32 for detecting the leading end position of a sheet is arranged upstream of the secondary transfer roller 43. The number of revolutions (sheet conveying velocity) of the pair of registration rollers 31 is adjusted on the basis of toner image leading end position information from the patch sensor 47 and sheet leading end position information from the sheet sensor 32. In this way, the leading end of a sheet aligns with that of an image, and then the toner image is transferred onto the sheet.

The patch sensor 47 may detect the position of a toner image in the main scanning direction (direction perpendicular to the conveyance direction), and the registration sensor 32 may detect the position of a sheet in the main scanning direction, detecting the positional discrepancy between a toner image and a sheet. The pair of registration rollers 31 is movable in the main scanning direction of a sheet. While nipping a sheet, the pair of registration rollers 31 moves in the main scanning direction on the basis of the detected positional discrepancy amount between the toner image and the sheet in the main scanning direction. This arrangement can also correct the positional discrepancy between a sheet and a toner image in the main scanning direction.

In the structure of FIG. 17, the patch sensor 47 is positioned above the pair of registration rollers 31. In the apparatus illustrated in FIG. 17, the sheet conveying path and patch sensor 47 are arranged so as not to interfere with each other, which makes the whole apparatus bulky. To prevent this, Japanese Patent Laid-Open No. 11-242370 proposes reducing the size of an apparatus by interposing a conveying path between a photosensitive belt and a patch sensor. Japanese Patent Laid-Open Nos. 05-002302 and 11-282223 propose techniques of using a patch sensor as a sheet jam detection sensor. This arrangement can decrease the number of sensor installation portions and reduce the size of the apparatus.

However, these patent references do not describe alignment of the position of a toner image formed on a transfer belt with a sheet to which the image is transferred in an image forming apparatus. That is, these patent references propose reducing the size of the apparatus, but do not propose an image forming apparatus which implements both a size reduction of the apparatus, and an alignment of the position of a toner image formed on a transfer belt with a sheet to which the image is transferred.

Some image forming apparatuses allow extraction of a sheet conveying path-forming unit from the apparatus main body in order to eliminate sheet jams and the like. For example, in FIG. 18, conveying unit A as a combination of the registration unit 30, secondary outer transfer roller 44, conveyance belt 51, and fixing device 50 is detachable from the apparatus main body in a direction indicated by arrow a.

Conveying unit B on the outer side of the sheet conveying unit 20 is pivotal in a direction indicated by arrow b. In this structure, the patch sensor 47 and sheet sensor 32 are separated into different units when extracting conveying unit A from the apparatus main body. Each time the registration unit 30 is mounted and dismounted, its mounting position may vary to change the positional relationship between the patch sensor 47 and the sheet sensor 32. The change in the relative positions of the sensors leads to the positional discrepancy between a sheet and an image.

### SUMMARY OF THE INVENTION

An embodiment of the present invention is directed to an image forming apparatus which is reduced in size as a whole and increases the positional precision of an image formed on a sheet, and a control method therefor. An embodiment of the present invention is directed an image forming apparatus which prevents a change of the position of an image formed on a sheet upon mounting/dismounting of a unit, and a control method therefor.

According to one aspect of the present invention, an image forming apparatus which forms a toner image on a sheet, comprises a forming unit which forms a toner image on a movable image carrier; a transfer unit which transfers the toner image formed on the image carrier onto a sheet at a transfer position; a sheet conveying unit which conveys the sheet so as to pass through the transfer position; a sensor which is arranged upstream of the transfer position and detects the sheet conveyed by the sheet conveying unit and the toner image formed on the image carrier or a position reference image; and a control unit which controls conveyance of the sheet by the sheet conveying unit on the basis of detection by the sensor so as to synchronize the sheet conveyed by the sheet conveying unit with the toner image formed on the image carrier.

An embodiment of the present invention can increase the positional precision of an image formed on a sheet, and decrease the overall apparatus size.

Further features of the present invention will become apparent from the following description of exemplary embodiments with reference to the attached drawings.

### BRIEF DESCRIPTION OF THE DRAWINGS

FIG. 1 is a sectional view showing the schematic structure of a copying machine and printer according to the first embodiment;

FIG. 2 is a sectional view showing the schematic structure of a copying machine and printer according to the first embodiment;

FIG. 3 is a sectional view for explaining the structure of a position detection sensor according to the first embodiment;

FIG. 4 is a graph showing a change of the voltage value used for discriminating a toner patch and sheet from each other according to the first embodiment;

FIG. 5 is a graph showing another example representing a change of the voltage value used for discriminating a toner patch and sheet from each other;

FIG. 6 is a block diagram according to the first embodiment;

FIG. 7 is a schematic view showing a structure from a registration unit to a secondary transfer unit according to the first embodiment;

FIG. 8 is a diagram of the instant of image formation according to the first embodiment;

FIG. 9 is a diagram of the instant of image formation according to the first embodiment;

FIG. 10 is a schematic view showing a color discrepancy correction operation according to the first embodiment;

FIG. 11 is a block diagram according to the second embodiment;

FIG. 12 is a schematic view showing the structure from the registration unit to the secondary transfer unit according to the second embodiment;

FIG. 13 is a sectional view showing the schematic structure of a copying machine and printer according to the third embodiment;

FIG. 14 is a sectional view showing the schematic structure of a copying machine and printer according to the third embodiment;

FIG. 15 is a diagram of the instant of image formation according to the third embodiment;

FIG. 16A is a flowchart depicting the flow of control of the conveying velocity switching timing according to the diagram in the first embodiment;

FIG. 16B is a flowchart depicting the flow of control of the conveying velocity switching timing according to the diagram in the first embodiment;

FIG. 16C is a flowchart depicting the flow of control of the conveying velocity switching timing according to the diagram in the first embodiment;

FIG. 16D is a flowchart depicting the flow of control of the conveying velocity switching timing according to the diagram in the first embodiment;

FIG. 17 is a sectional view showing the schematic structure of a conventional copying machine and printer; and

FIG. 18 is a sectional view showing the schematic structure of a conventional copying machine and printer.

### DESCRIPTION OF THE EMBODIMENTS

### First Embodiment

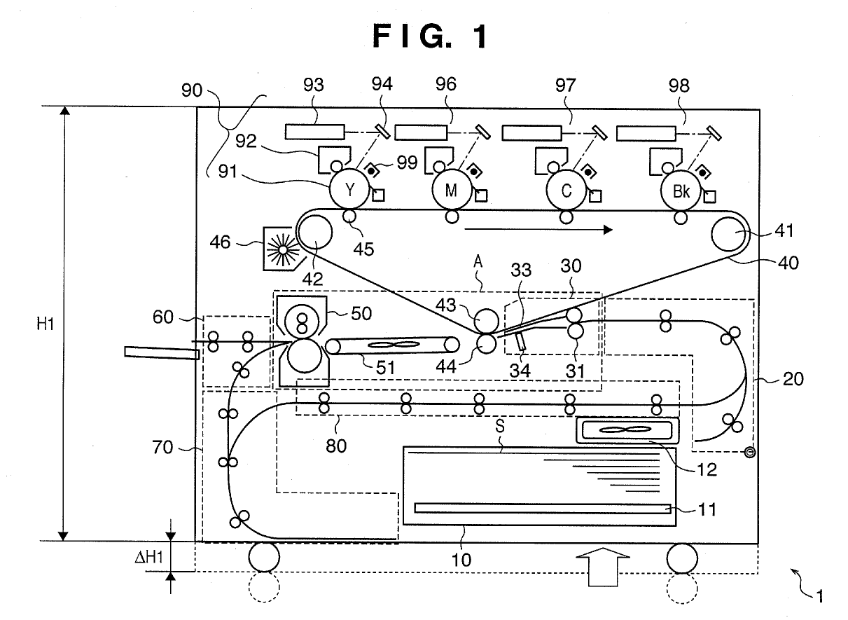

An application of embodiments of the present invention to an electrophotographic image forming apparatus will be explained. FIG. 1 is a sectional view showing the schematic structure of an image forming apparatus such as a copying machine or printer according to the first embodiment.

The image forming section comprises a yellow station 90, magenta station 96, cyan station 97, and black station 98. Components of the respective stations will be explained by using the yellow station 90 as an example. A scanner unit 93 converts image information sent from a controller (not shown) into a laser beam to be emitted from a laser-emitting portion, and horizontally scans a polygon mirror with the laser beam. The scanner unit 93 receives image information from an image reading unit (not shown), personal computer (PC), server, or the like. A laser beam from the scanner unit 93 is reflected by a reflecting mirror 94 toward a photosensitive drum 91 to irradiate the photosensitive drum 91 along a predetermined generatrix.

A charger 99 for unifying negative charges on the drum is arranged upstream of the laser irradiation position. The drum surface is coated with a photoconductive film, and charges are removed from the portion irradiated with a laser beam. This process is repeated to form an electronic image (latent image) on the drum surface. The latent image formed on the drum surface is sent to a developing unit 92 for uniform application of toner. Toner is charged positively in the developing unit 92, and attaches only to the negatively charged portions of the surface of the photosensitive drum 91. A toner image is obtained by developing the electrostatic latent image with toner. Although the charge polarity may be opposite depending on the type of toner, the first embodiment employs a positively charged toner. The toner image formed on the drum is sent to an intermediate transfer belt 40 and pressed by a transfer roller 45. The drum supplies a transfer current to the transfer roller 45 via the intermediate transfer belt 40 to uniformly transfer the toner image onto the intermediate transfer belt 40.

The image forming apparatus separates color image data into yellow (Y), magenta (M), cyan (C), and black (Bk). The respective image forming stations transfer multiple toner images onto the intermediate transfer belt 40 to form a color image. The intermediate transfer belt 40 is an image carrier on which a toner image to be printed is formed. The above-described scanner unit, photosensitive drum and developing unit function as a forming unit which forms a toner image on the intermediate transfer belt 40 serving as an image carrier.

The intermediate transfer belt 40 is suspended by a driving roller 42, steering roller 41, and secondary transfer roller 43. The driving roller 42 drives the belt. The steering roller 41 controls the movement of the belt, and applies tension. The secondary transfer roller 43 transfers, to a sheet, multiple transferred images. A secondary outer transfer roller 44 is positioned to face the secondary transfer roller 43. A cleaner 46 is positioned downstream of the secondary transfer roller 43 to recover toner remaining on the intermediate transfer belt 40. The pair of transfer rollers functions as a transfer unit which transfers, onto a sheet at the transfer position, a toner image formed on the image carrier.

A paper feed deck 10 on which sheets S are stacked and stored is mounted in an detachable manner at the lower portion of the copying machine. A paper feed deck 12 comprises a lifter plate 11 which can move up and down while supporting sheets. A suction conveying unit for conveying sheets is arranged above the lifter plate 11. The suction conveying unit is formed from a conveyance belt, suction fan, and sheet surface detection sensor. A sheet S is chucked to the conveyance belt by the suction fan, and the conveyance belt rotates to separate and convey the sheet S downstream. The lifter plate 11 moves up and down to make the top position of sheets on the lifter plate 11 flush with a position optimal for attraction; it does so on the basis of a detection signal from the sheet surface detection sensor (not shown). This implements sheet conveyance free from any sheet conveyance failure or overlapping feed.

Overlapping feed of sheets is further prevented by blowing air to sheets in order to separate sheets in the conveyance direction of the sheet S and a direction perpendicular to the conveyance direction (i.e., a direction toward the far side from the sheet surface of FIG. 1). Then, one separated sheet S is fed to a registration unit 30 via a sheet conveying unit 20.

The registration unit 30 adjusts the sheet position. The registration unit 30 comprises a pair of registration rollers 31 for correcting sheet skew, and a pre-transfer guide 33 almost juxtaposed with the transfer belt 40.

In the registration unit 30, a position detection sensor 34 is interposed between the downstream of the pair of registration rollers 31 and the upstream of the secondary transfer roller 43. The position detection sensor 34 detects the leading end position of a sheet, and the leading end positions of multiple toner images transferred on the transfer belt 40. That is, in an embodiment, the position detection sensor 34 is constructed as a single integrated inseparable sensor which is capable of detecting, on the upstream of the transfer position, the position of a sheet and the position of a toner image formed on the transfer belt serving as an image carrier. The concrete structure of the position detection sensor 34 will be described in detail later. In order to detect the leading end position of a toner image, the first embodiment forms a toner patch serving as a position reference image for detection on the front side (front side in the rotational direction) of the toner image, detects the toner patch without directly detecting the toner image, and determines the leading end position of the toner image on the basis of the detection.

A loop is formed by a sheet S, conveyed by the sheet conveying unit 20, by a pair of pre-registration rollers 21 pressing the sheet S against the pair of registration rollers 31 which are at rest. As a result, the leading end of the sheet S aligns with the nip line of the pair of registration rollers 31, correcting the skew. Conveyance of the skew-corrected sheet S by the pair of registration rollers 31 is controlled so that the sheet conveyed by the pair of registration rollers 31 synchronizes with an image (toner image) on the basis of information from the position detection sensor 34 about the leading end positions of the toner patch and sheet. More specifically, the pair of registration rollers 31 conveys the sheet so that the leading end of the sheet aligns with that of the toner image. The toner image on the intermediate transfer belt 40 is transferred onto the sheet S conveyed by the pair of secondary transfer rollers 43 and 44.

The sheet S bearing the toner image is guided to a fixing device 50 by a conveyance belt 51. When the sheet S passes through a fixing roller and pressing roller, heat and pressure are applied to fuse the toner image onto the sheet S. In the single copy mode, the sheet S having undergone the fixing process is discharged outside the apparatus via a delivery unit 60. The pair of registration rollers 31 also functions as a sheet conveying unit which conveys a sheet so as to pass through the transfer position.

The image forming apparatus has a duplex copy mode in which the sheet S undergoes duplex copying. In the duplex copy mode, after passing through the fixing roller and pressing roller of the fixing device, the sheet S is guided to a reversing unit 70. After the reversing unit 70 reverses the conveyance direction of the sheet S, the sheet S passes through a refeed path formed in a refeed unit 80, and is conveyed to the registration unit 30 in order to form an image again. Then, the sheet S undergoes the same process as single copy printing, and is discharged outside the apparatus.

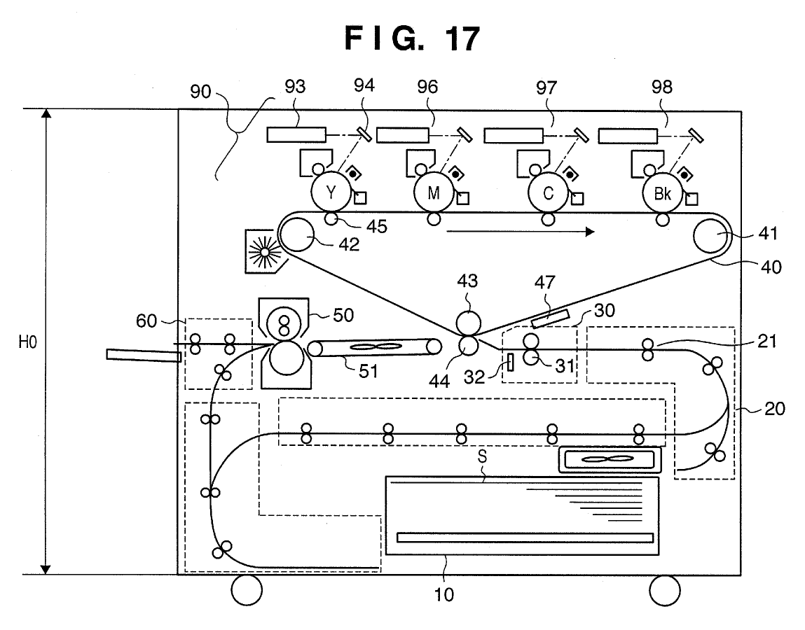

In the first embodiment, the pre-transfer guide 33 need not be arranged while detouring around the position detection sensor 34 within the height H0 of the conventional image forming apparatus shown in FIG. 17. Thus, the height of the image forming apparatus according to the first embodiment can be decreased to H1 smaller than H0 by ΔH1. In addition, performance can be improved by increasing the stacking capacity of the paper feed deck 12 by the height ΔH1.

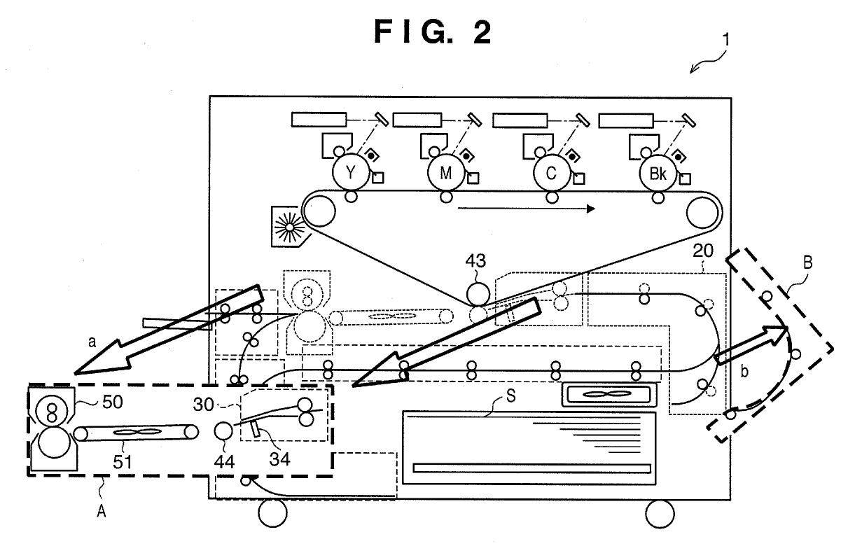

FIG. 2 shows a state in which a problem such as a sheet jam occurs in the registration unit 30, the pair of secondary transfer rollers 43 and 44, or the conveyance belt 51, and units for solving the problem in an extracted state. In eliminating a sheet jam, conveying unit B on the outer side of the conveying unit 20 is pivoted in a direction indicated by arrow b to remove a sheet jammed in the conveying unit 20. Then, conveying unit A as a combination of the registration unit 30, secondary outer transfer roller 44, conveyance belt 51, and fixing device 50 is extracted in a direction indicated by arrow a. A sheet jammed in the fixing device 50 is removed from the registration unit 30. At this time, the position detection sensor 34 in the registration unit 30 is dismounted/mounted from/within the main body together with conveying unit A.

<Position Detection Sensor>

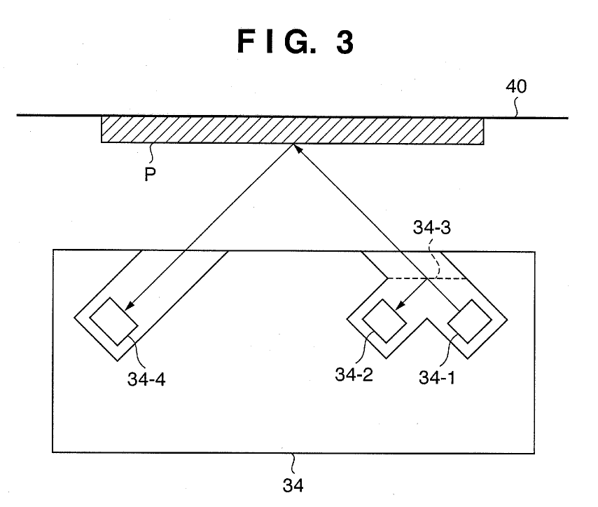

FIG. 3 is a sectional view showing a concrete structure of the position detection sensor 34. The position detection sensor 34 is a reflecting sensor made up of a light-emitting portion 34-1 using a light-emitting diode (LED), light-receiving portions 34-2 and 34-4, and a partially reflecting surface 34-3. The light-emitting portion 34-1 emits light toward the intermediate transfer belt 40 (also referred to herein as “image carrier”), a toner patch P serving as a position reference image formed in advance on the intermediate transfer belt 40, and a sheet S (to be referred to as a sheet or the like) conveyed by the pair of registration rollers 31. Note that FIG. 3 does not illustrate the sheet S. The partially reflecting surface 34-3 reflects light emitted by the light-emitting portion 34-1 at a predetermined ratio. The remaining light passes through the partially reflecting surface. The light-receiving portion 34-2 receives light reflected by the partially reflecting surface 34-3, and converts it into a voltage signal corresponding to the received light quantity (or light intensity). The light-receiving portion 34-2 further converts the voltage signal into a digital signal (to be referred to as a voltage signal) representing a voltage value. The voltage signal output from the light-receiving portion 34-2 is input to a CPU 201 (to be described later) as a reference signal representing the quantity of light emitted by the light-emitting portion 34-1. On the other hand, the light-receiving portion 34-4 receives light which passes through the partially reflecting surface 34-3 and is reflected by a sheet or the like. The light-receiving portion 34-4 outputs a voltage signal corresponding to the light quantity. The voltage signal output from the light-receiving portion 34-4 is input to the CPU 201 as the detection signal of the sheet or the like. Even if the emitted light quantity changes due to wear or contamination of the light-emitting portion 34-1 or the like, the ratio between the reference signal and the detection signal is constant unless the reflectance of a sheet or the like for transmitted light changes. Hence, the ratio between the reference signal and the detection signal represents a value corresponding to the reflectance of a sheet or the like regardless of the emitted light quantity. In the first embodiment, the ratio between the reference signal and the detection signal is also simply called the reflectance.

The CPU 201 determines one of the intermediate transfer belt 40, toner patch P, and sheet S on the basis of a reference signal (voltage value) from the light-receiving portion 34-2 and a detection signal (voltage value) from the light-receiving portion 34-4. The CPU 201 can determine whether the front end of the toner patch P or the leading end of the sheet S has reached a predetermined position.

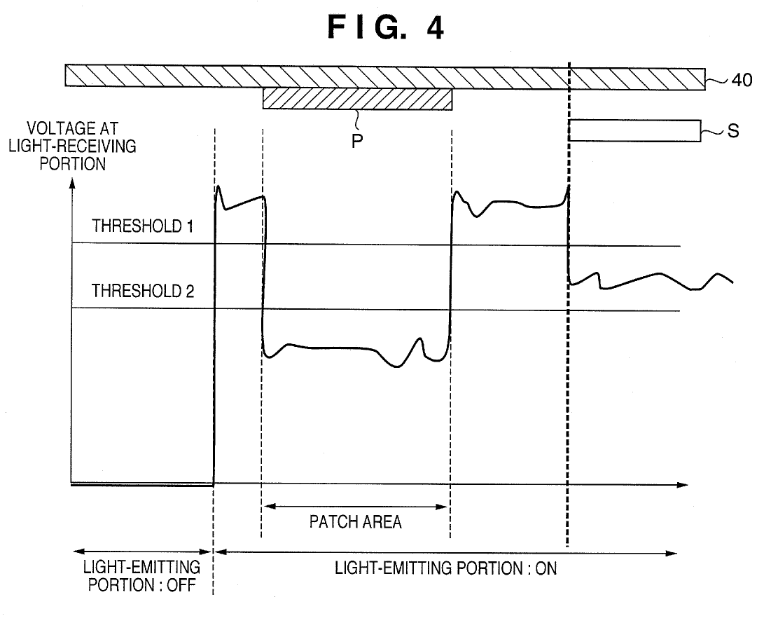

Discrimination between the intermediate transfer belt 40, the toner patch P, and the sheet S by the CPU 201 will be explained. FIG. 4 is a graph showing the ratio between the light-receiving portion voltage (reference signal value) of the light-receiving portion 34-2 and the light-receiving portion voltage (detection signal value) of the light-receiving portion 34-4 in the position detection sensor 34 when the position detection sensor 34 is attached to a center attachment position. The process determination by the CPU 201 will be described with reference to FIG. 4. In FIG. 4, the reflectance of the intermediate transfer belt 40 is the highest, that of the sheet S is the second highest, and that of the toner patch P is the lowest.

These reflectances are measured in advance to determine thresholds 1 and 2 in FIG. 4. For example, these thresholds may be defined experimentally. For this purpose, each of the sheet S, toner patch P, and intermediate transfer belt 40 is set at the detection position of the position detection sensor 34 to measure a reference signal value and detection signal value by the position detection sensor 34 at this time. The ratios between detection signal values and reference signal values are calculated for the sheet S, toner patch P, and intermediate transfer belt 40. Intermediate values between these ratios are defined as thresholds 1 and 2. It is predicted that the reflectance of the surface of the sheet S varies depending upon the quality. For this reason, this measurement is executed for a plurality of types of sheets so as to determine even a sheet S of a different material as a sheet. Thresholds are preferably decided such that measurement values for the plurality of types of sheets fall between threshold 1 and threshold 2.

Assuming that the reference signal value is constant, the ratio between the reference signal value and the detection signal value depends only on the detection signal value. For example, FIG. 4 shows the voltage (i.e., detection signal value) of the light-receiving portion 34-4 along the ordinate axis.

Upon receiving a reference signal and detection signal, when the ratio between the reference signal value and the detection signal value changes from threshold 1 or more to less than threshold 2, the CPU 201 determines that the leading end of the image of the toner patch P transferred on the intermediate transfer belt 40 has reached the position of the position detection sensor 34. Further, when the ratio between the reference signal value and the detection signal value changes from threshold 1 or more to less than threshold 1 and threshold 2 or more the CPU 201 determines that the leading end of the sheet S has reached the detection position of the position detection sensor 34. The CPU 201 makes these determinations by executing a program prepared in advance. The ratio between the reference signal value and the detection signal value may also be input to the CPU 201.

When the reflectances of the toner patch P and sheet S are not so different, thresholds 1 and 2 may be set equal. In this case, the CPU 201 determines that the end of the toner patch P has reached the detection position of the position detection sensor 34 when the ratio between the reference signal value and the detection signal value changes from the threshold or more to less than it. After the ratio between the reference signal value and the detection signal value changes to the threshold or more, and then to less than it again, the CPU 201 determines that the leading end of the sheet S has reached the detection position of the position detection sensor 34.

Conveyance of the sheet S is controlled so that the position detection sensor 34 can detect the leading end of the image of the toner patch P prior to that of the sheet S.

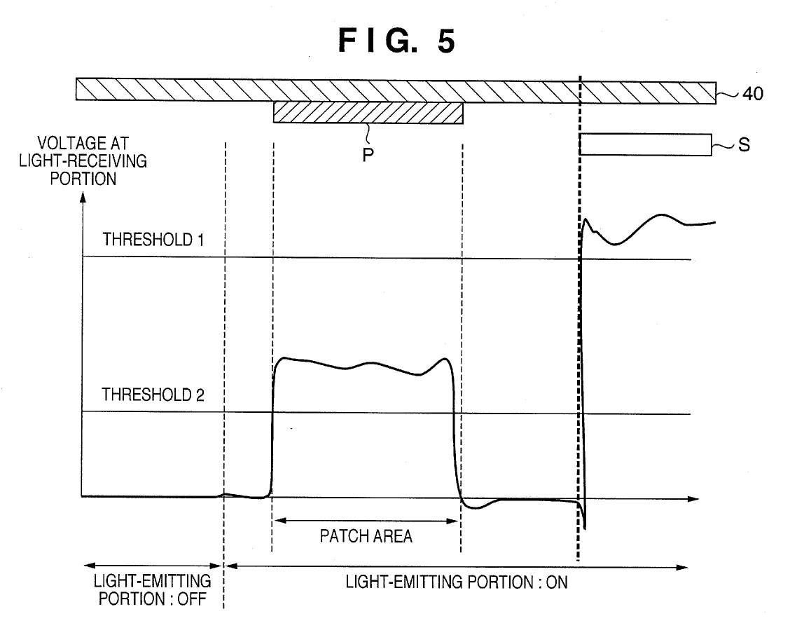

Another detection method will be explained. FIG. 5 is a graph showing the ratio between a reference signal value and a detection signal value from the position detection sensor 34 when the position detection sensor 34 is attached to a center attachment position. In FIG. 5, unlike FIG. 4, the reflectance of the intermediate transfer belt 40 is the lowest, that of the toner patch P is the second lowest, and that of the sheet S is the highest.

The CPU 201 determines that the leading end of the image of the toner patch P has reached the detection position of the position detection sensor 34 when the ratio between the reference signal value and the detection signal value from the position detection sensor 34 changes from less than threshold 2 to threshold 2 or more and less than threshold 1. Further, the CPU 201 determines that the leading end of the sheet S has reached the detection position of the position detection sensor 34 when the voltage from the light-receiving portion of the position detection sensor 34 changes from less than threshold 2 to threshold 1 or more.

When the reflectances of the toner patch P and sheet S are not so different, thresholds 1 and 2 may be set equal. In this case, the CPU 201 determines that the end of the toner patch P has reached the detection position of the position detection sensor 34 when the ratio between the reference signal value and the detection signal value changes from less than the threshold to the threshold or more. After the ratio between the reference signal value and the detection signal value changes to less than the threshold, and then to the threshold or more again, the CPU 201 determines that the leading end of the sheet S has reached the detection position of the position detection sensor 34.

Also in this example, conveyance of the sheet S is controlled so that the position detection sensor 34 can detect the leading end of the image of the toner patch P prior to that of the sheet S.

In this way, the position detection sensor 34 can determine the phase of the intermediate transfer belt by associating the range of the ratio between the reference signal value and the detection signal value from the position detection sensor 34 with a material (e.g., the toner patch P, sheet S, or intermediate transfer belt) which reflects light. Although the association may be coded in a program, the association can be saved in a table or the like to enable more flexible maintenance.

<Image Position Correction Control>

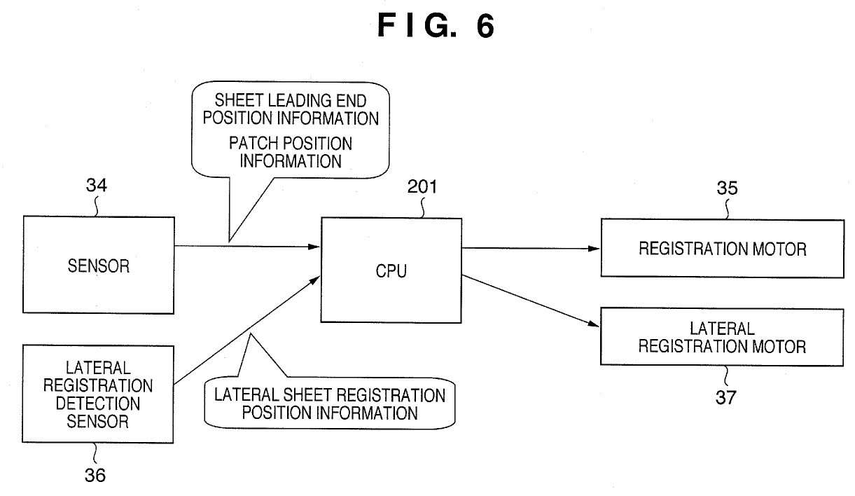

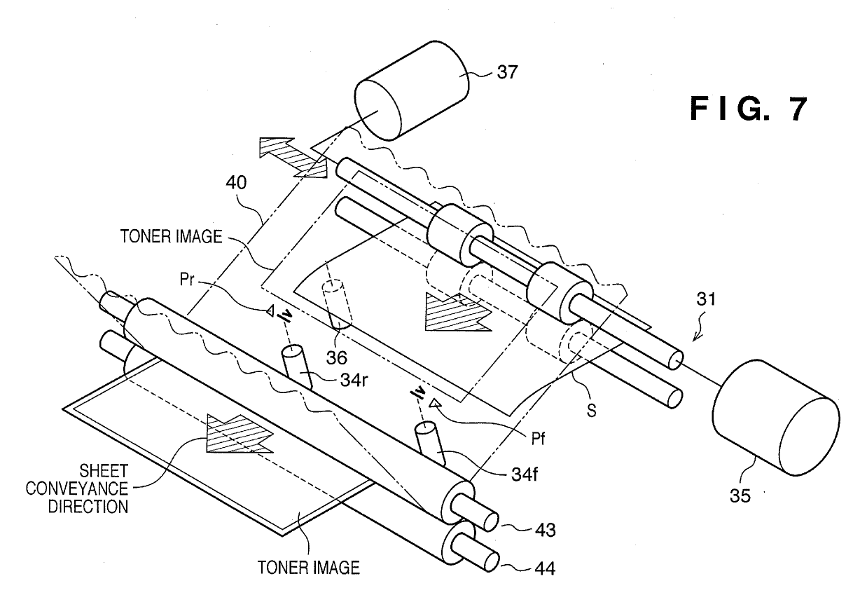

Image position correction control procedures to align a sheet with an image in the arrangement of FIG. 1 using the position detection sensor as both a toner patch (position indication pattern) detection sensor and sheet leading end detection sensor will be explained with reference to FIGS. 6 to 9. FIG. 6 is a block diagram of the image forming apparatus according to the first embodiment. FIG. 7 is a schematic perspective view showing a structure from the pair of registration rollers 31 to the pair of secondary transfer rollers 43 and 44.

In FIG. 7, a roller driving motor 35 and lateral registration motor 37 are attached to the pair of registration rollers 31. The roller driving motor 35 can freely control the number of revolutions. The lateral registration motor 37 moves the pair of registration rollers 31 toward the rotating shaft. A lateral reference sensor 36 is arranged downstream of the pair of registration rollers 31. The lateral reference sensor 36 detects whether a sheet is at a reference position in the lateral direction (i.e., direction perpendicular to the sheet conveyance direction). The lateral reference sensor 36 corresponds to a lateral position detection unit which detects the position of a sheet in the lateral direction perpendicular to the sheet conveyance direction. Two position detection sensors 34f and 34r are attached to one attachment member. The position detection sensors 34f and 34r detect a position indication pattern and sheet leading end, respectively. As shown in FIG. 7, the position detection sensors 34f and 34r detect two position indication patterns Pf and Pr formed on the near and far sides on the intermediate transfer belt 40. From this, the position detection sensors 34f and 34r can detect the position and tilt of an image in the conveyance direction, the position of the image in the main scanning direction, the image magnification, and the like. For example, the position indication patterns Pf and Pr have the inequality sign as shown in FIG. 7. The distance between the position indication patterns Pf and Pr is set to be equal to that between the position detection sensors 34f and 34r when the image enlargement magnification is an equal magnification.

The position indication pattern Pf is formed from “>”, and one line segment which is perpendicular to the conveyance direction of the intermediate transfer belt 40 and precedes “>” in the conveyance direction. That is, the position indication pattern Pf is formed from three line segments which are not parallel to each other. When the position indication pattern Pf passes above the position detection sensor 34f, a signal output from the position detection sensor 34f changes in accordance with the positional relationship with the position indication pattern Pf. Assume that a sensor output signal is “1” when detecting a toner portion. When almost the center of the position indication pattern Pf is detected, signals output from the position detection sensor 34f are 1, 0, 1, 0, and 1 because three lines pass above the sensor. Note that values before and after these output signals are 0. Line segments which form the position indication pattern Pf are not parallel to each other. If the positional relationship between the position indication pattern Pf and the position detection sensor 34f changes in the lateral direction, the duration of “0” in the output pattern “1, 0, 1, 0, 1” takes a value proportional to the discrepancy amount. The lateral direction is a direction perpendicular to the sheet conveyance direction, and is also called the main scanning direction. Thus, the intervals between is out of the signal values of 1, 0, 1, 0, and 1 represent a discrepancy amount in the lateral direction. This also applies to the position indication pattern Pr and position detection sensor 34r. A detected position in the direction perpendicular to the sheet conveyance direction is called the lateral position.

When the image forming magnification is an equal magnification, signal patterns detected by the position detection sensors 34f and 34r coincide with each other. This is because the distance between position indication patterns formed at the equal magnification is equal to that between the position detection sensors. However, when the image forming magnification is not the equal magnification, the distance between position indication patterns takes a value corresponding to the magnification, and signal patterns detected by the position detection sensors 34f and 34r do not coincide with each other. The discrepancy between signal patterns detected by the position detection sensors 34f and 34r, i.e., the interval difference between signals of the output value “1” can be converted into the distance between the position indication patterns Pf and Pr. However, this is limited to a case where both the position detection sensors 34f and 34r detect position indication patterns. No magnification can be detected when either or both of position indication patterns deviate from the position detection sensor 34 and are not detected.

The discrepancy amount between the positions of a sheet and image that should normally coincide with each other can be detected from the time difference between the timing when the position detection sensors 34f and 34r detect position indication patterns and the timing when they detect the leading end of a conveyed sheet.

The lateral reference sensor 36 can detect the position of a sheet in the main scanning direction. Based on these detection results, the roller driving motor 35 and lateral registration motor 37 are controlled to correct the positional discrepancy between a sheet and a toner image.

As shown in FIG. 6, signals output from the position detection sensor 34 and lateral reference sensor 36 are input to the CPU 201 which controls the image forming operation of the image forming apparatus. Based on these signals, the CPU 201 controls the timing when changing the driving velocity of the roller driving motor 35. Also based on these signals, the CPU 201 drives the lateral registration motor 37. The sheet position is adjusted to coincide with the toner image position. In other words, the lateral registration motor 37 corresponds to a lateral adjustment unit which adjusts the sheet position on the basis of a lateral position detected by the lateral position detection unit (lateral reference sensor 36) so that a sheet and toner image in the lateral direction align with each other.

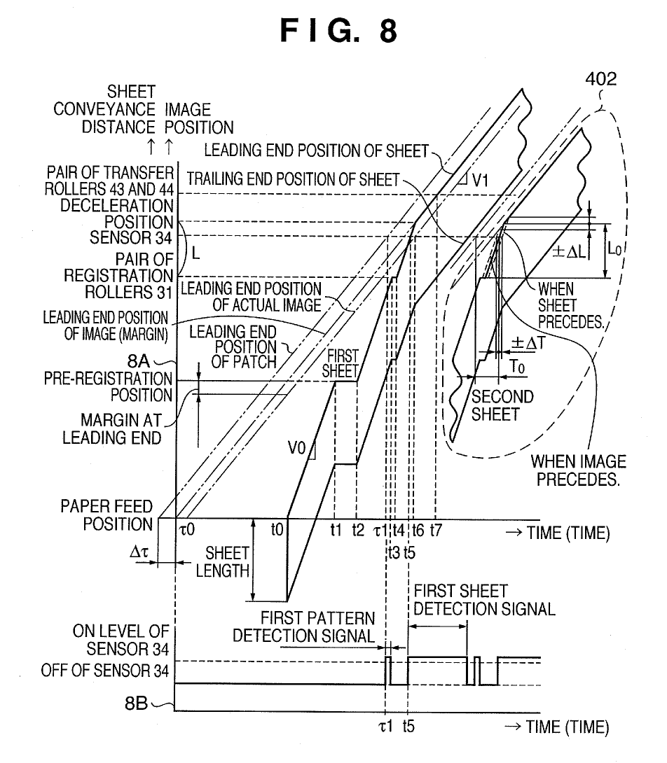

Image formation control by the CPU 201 will be described in detail with reference to a diagram 8A in FIG. 8. In the following description, the CPU 201 will be referred to as a control unit. The following operations (1) to (8) are executed under the control of the control unit (CPU 201). A patch in FIG. 8 means a position indication pattern (toner patch).

(1) When a controller (not shown) which controls image information from an image reading unit, PC, server, or the like sends image information, image formation on the photosensitive drum starts on the basis of the image information (time τ0). An image of a position indication pattern is formed time Δτ before time τ0. The position indication pattern is used to correct the positions of a sheet and image, and suffices to be formed in a specific color (e.g., black). However, a pattern for correcting an image discrepancy for each color component must be formed for each color.

(2) The image and position indication pattern formed on the photosensitive drum are transferred to the intermediate transfer belt 40. The intermediate transfer belt 40 moves at the velocity V0, and the position detection sensor 34 detects the position of the position indication pattern at time 1.

(3) The paper feed operation is done a predetermined time after the start of image formation (time τ0). A sheet is conveyed from the paper feed unit 12 to the sheet conveying unit 20 (time t0). In the first embodiment, the conveying velocity is V0 equal to the moving velocity of the intermediate transfer belt 40.

(4) The sheet conveying unit 20 temporarily stops conveyance (time t1) in order to absorb variations in conveyance timings by the paper feed unit 12 and sheet conveying unit 20. At a predetermined timing, the sheet conveying unit 20 restarts conveying the sheet (time t2). This is called pre-registration control, and the position where a sheet temporarily stops is called a pre-registration position.

(5) The pair of pre-registration rollers 21 pushes the sheet conveyed by the sheet conveying unit 20 into the pair of registration rollers 31 at rest. The sheet forms a loop and stops (time t3). The stopped sheet S is kept pushed to make its leading end coincide with the nip line of the pair of registration rollers 31, correcting the sheet skew. At time t4 a predetermined time after the image formation start time τ0, the pair of registration rollers 31 starts rotating at a velocity V1 higher than the velocity V0. The sheet S which has stopped after abutted against the pair of registration rollers 31 is conveyed (time t4).

(6) At time t5, the position detection sensor 34 and lateral reference sensor 36 detect the position of the sheet supplied at the conveying velocity V0. At this time, the leading end position of the sheet falls between the position of the position indication pattern on the intermediate transfer belt 40 and the position of an actual image (image to be transferred onto a sheet). A signal output from the position detection sensor 34 at this time is as shown in a graph 8B in FIG. 8.

(7) The distance by which the sheet is conveyed at the conveying velocity V0 from the pair of registration rollers 31 to a sheet deceleration start position is defined as an acceleration conveyance distance L. The CPU 201 calculates the acceleration conveyance distance L on the basis of position indication pattern passing time τ1 and sheet passing time t5 at the position detection sensor 34. The sheet supplied by the pair of registration rollers 31 at the conveying velocity V0 is conveyed by the acceleration conveyance distance L, and then decelerated to the velocity V1. The acceleration conveyance distance L is given by

$$\begin{matrix}L = L 0 + Δ L \\ = L 0 + ( V 0 - V 1 ) * Δ T \\ = L 0 + ( V 0 - V 1 ) * ( ( t 5 - τ1 ) - T 0 )\end{matrix} \qquad ( 1 )$$

In equation (1), L0 represents an acceleration conveyance distance when no sheet deviates from the position indication pattern. That is, L0 represents an originally designed acceleration conveyance distance free from any error. ΔL represents variations in acceleration conveyance distance owing to the individual difference of the image forming apparatus. T0 represents the time until the leading end of the sheet passes after the position indication pattern passes when no sheet deviates from the position indication pattern. That is, T0 represents an originally designed value free from any error. ΔT represents the difference between the time T0 free from any error, and the time (t5-τ1) until the leading end of the sheet passes through the position detection sensor 34 after the position indication pattern passes through it. The distance between the position indication pattern and the leading end of the toner image (leading end of the image area for one page) is kept constant. Thus, the time ΔT has a value representing the discrepancy in the conveyance direction between the position of the sheet and that of the toner image formed on the intermediate transfer belt 40.

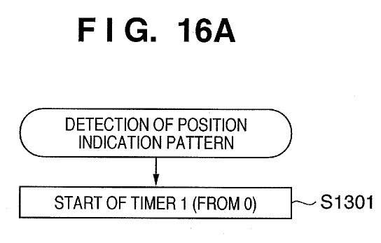

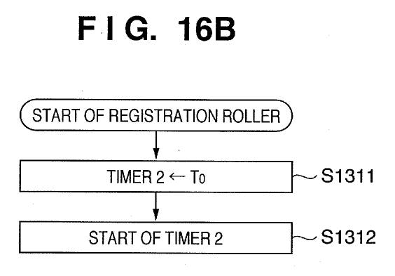

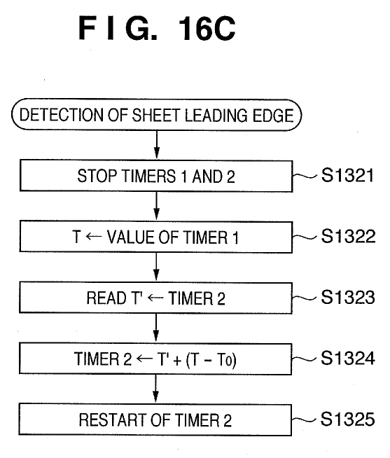

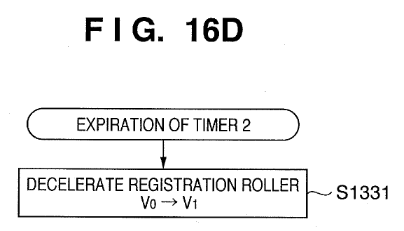

FIGS. 16A to 16D show an example of control procedures centered on the above-described procedure (7) by the CPU 201. The CPU 201 executes the sequence in FIG. 16A upon receiving a position indication pattern detection signal from the position detection sensor 34. At this time, the CPU 201 initializes an up-counting timer 1 to 0, and then starts it (S1301). The position indication pattern has a specific shape as described above, and the sensor outputs a signal corresponding to the shape. Hence, the CPU 201 can specify the position indication pattern from the signal pattern. The timer 1 desirably starts at the timing when the front edge of the position indication pattern in the conveyance direction is detected. This is because the front edge of the position indication pattern is a parallel line segment in the main scanning direction, and no time difference in the conveyance direction appears even if the detection position deviates in the lateral direction. According to the aforementioned discrimination method, the CPU 201 cannot determine at the front edge detection timing whether the detected signal represents part of the position indication pattern. For this reason, when the front edge is detected, the CPU 201 temporarily starts the timer 1, and if it determines that the detected signal does not represent the position indication pattern, cancels the timer 1.

The CPU 201 executes the sequence in FIG. 16B immediately after starting driving the pair of registration rollers 31 at timing t4. At this timing, the CPU 201 sets a value T0 determined in advance in design in a timer 2 operating as a down counter (S1311). Then, the CPU 201 starts the timer 2 (S1312).

The CPU 201 executes the sequence in FIG. 16C when the position detection sensor 34 detects the leading end of a sheet. The CPU 201 stops both the timers 1 and 2 (S1321). The CPU 201 reads the value of the timer 1 and sets it in the variable T (S1322). The CPU 201 reads the current value (value counted down from an initial value) of the timer 2 and sets it in the variable T′ (S1323). The CPU 201 sets a value T′+(T−0) as an initial value in the timer 2 again (S1324), and restarts the timer 2 (S1325).

However, it is difficult from detection of only the leading end of a sheet to determine whether the leading end is that of the sheet. Thus, the position detection sensor 34 detects a change of the light reflectance. If the changed state continues for a predetermined time, it can be determined that the detected leading end is that of a sheet. Also in this case, the leading end of a sheet can be determined only a predetermined time after detection of the leading end. The predetermined time necessary for the determination must be further subtracted from the time to be set in the timer 2 in step S1324. It is desirable to obtain the time necessary for the process from steps S1321 to S1325 in advance and further subtract the obtained time from the time to be set in the timer 2 in step S1324. Note that the reflectance is represented by the ratio between a detection signal from the light-receiving portion 34-4 and a reference signal from the light-receiving portion 34-2.

FIG. 16D shows a process when the timer 2 outputs an expiration signal. The expiration of the timer 2 represents that the registration rollers have conveyed a sheet by the acceleration conveyance distance L. The CPU 201 decreases the conveying velocity of the pair of registration rollers 31 from V0 to V1 (S1331). The control operations in FIGS. 16A to 16D do not consider the transition time necessary to change the number of revolutions of the motor. The motor specifications determine the time necessary to decrease the number of revolutions for the conveying velocity V0 to that for the conveying velocity V1 without step-out. Hence, the time necessary to change the motor velocity is converted into the time necessary to convey a sheet at the velocity V0. In step S1324 of FIG. 16C, the converted value is reflected in the time to be set in the timer 2. This implements control considering the transition time. The value of the timer 2 is changed during counting, as shown in FIG. 16C, because the timing when the position detection sensor 34 detects the leading end of a sheet is the timing before the conveying velocity decreases to the velocity V1 after the pair of registration rollers 31 rotate to restart conveying the sheet at the velocity V0, and this timing does not affect sheet conveyance.

Before the sheet conveying velocity decreases in FIG. 16D, the sheet is adjusted in the lateral direction. The following procedure (8) starts after the sequence of FIG. 16C and is complete before the sequence of FIG. 16D.

(8) The lateral registration motor 37 is driven to correct the lateral position of a sheet on the basis of the main scanning position of a position indication pattern detected by the position detection sensor 34 and the lateral position of the sheet detected by the lateral reference sensor 36. The pair of registration rollers 31 is slidable along the shaft by a registration roller sliding unit, and their slide amount is controlled by the lateral registration motor 37.

(9) The sheet which is decelerated to the conveying velocity V1 and undergoes lateral position correction is supplied to the secondary transfer rollers 43 and 44. While the sheet position coincides with the image position, the toner image is transferred onto the sheet. After the trailing end of the sheet passes through the pair of registration rollers 31, the lateral registration motor 37 rotates reversely to return the pair of registration rollers 31 to the initial position.

When adjusting the positions of successively conveyed sheets, the aforementioned procedures (2) to (8) are repeated.

The above-described control is to control sheet conveyance by the sheet conveying unit so that a sheet conveyed by the sheet conveying unit synchronizes with a toner image. More specifically, sheet conveyance is so controlled as to align a toner image with a sheet conveyed by the sheet conveying unit at the transfer position on the basis of detection of the sheet and toner image by the sensor 34. The CPU 201 serving as a control unit executes this control. Prior to a toner image, the sensor 34 detects the leading end position of a conveyed sheet and a position indication pattern formed on the conveyance belt. On the basis of the detection result, sheet conveyance is so controlled as to align the toner image at the transfer position with the sheet conveyed by the sheet conveying unit. In the first embodiment, the moving velocity of a toner image on the image carrier is different from the conveying velocity of a sheet conveyed by the sheet conveying unit. Sheet conveyance is controlled by adjusting the sheet conveyance time by the sheet conveying unit. That is, the leading end of a toner image can be aligned with a sheet by adjusting, on the basis of detection by the sensor 34, the sheet conveyance time while the sheet is decelerated from the conveying velocity V0 to the conveying velocity V1.

The sheet conveyance deceleration timing can be controlled in the above-described manner to adjust the acceleration conveyance distance L. When the toner image position coincides with the sheet position, the sheet is decelerated to make the velocity of the intermediate transfer belt 40 equal to the conveying velocity of the sheet S. Consequently, an image free from any discrepancy in the conveyance direction and lateral direction is formed on the sheet. This increases the positional precision of the image formed on the sheet. The whole apparatus can be downsized, and a change of the position of an image formed on a sheet upon dismounting/mounting a unit can be prevented.

[Modification]

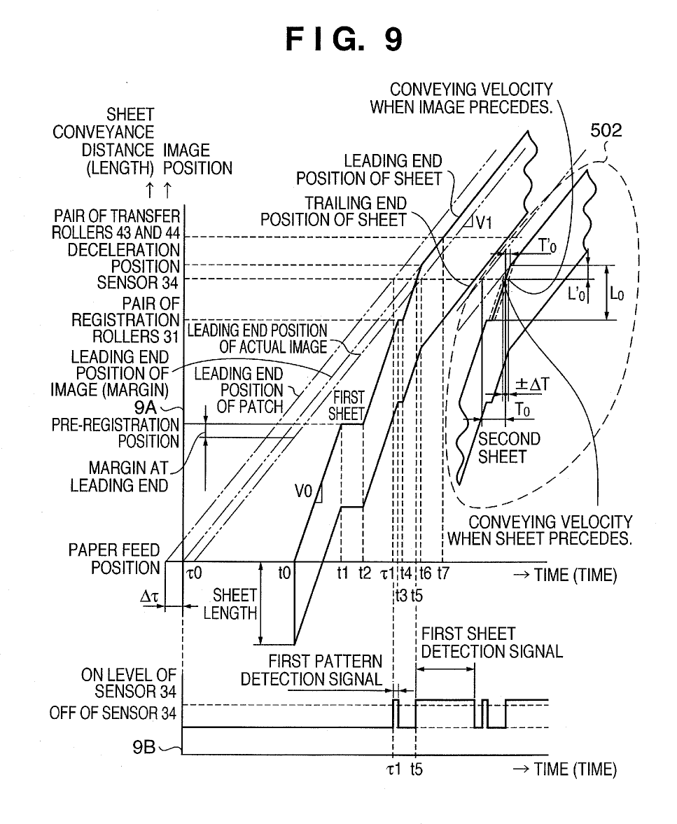

In procedure (7) of the first embodiment, the positions of the sheet leading end and image leading end are adjusted by changing the deceleration timing, i.e., the distance L. Instead, these positions can also be adjusted by changing the conveying velocity as shown in diagrams 9A and 9B of FIG. 9. In this modification, the moving velocity of a toner image on the image carrier is different from the conveying velocity of a sheet conveyed by the sheet conveying unit. Sheet conveyance is controlled by adjusting the sheet conveying velocity of the sheet conveying unit.

The velocity change section distance L′0 represents a conveyance distance from the detection position of the position detection sensor 34 to the deceleration start position, and V′ represents a conveying velocity at the velocity change section distance L′0. The CPU 201 calculates the conveying velocity V′ on the basis of time τ1 when the position detection sensor 34 detects a position indication pattern and time t5 when the position detection sensor 34 detects the leading end of a sheet. The sheet S is conveyed by the pair of registration rollers 31 at the conveying velocity V0 from the pair of registration rollers 31 to the position detection sensor 34. When the position detection sensor 34 detects the sheet S, the sheet S is conveyed at the conveying velocity V′. Further, the sheet S is decelerated to the velocity V1 at the deceleration start position after conveyed by the velocity change section distance L′0. The conveying velocity V′ in the velocity change section is given by

$$\begin{matrix}{V}^{′} = {L}^{′} 0 / ( {T}^{′} 0 - Δ T ) \\ = {L}^{′} 0 / ( {L}^{′} 0 / V 0 - Δ T ) \\ = {L}^{′} 0 / ( {L}^{′} 0 / V 0 - ( ( t 5 - τ1 ) - T 0 ) )\end{matrix} \qquad ( 2 )$$

The time T′0 is the conveyance time when a sheet is conveyed from the detection position of the position detection sensor to the deceleration start position without any discrepancy of the sheet from a position indication pattern. Both the time T′0 and velocity change section distance L′0 are constants set in accordance with the arrangement of sensors, registration rollers, and the like in designing an image forming apparatus. The velocity V′ can be determined by calculating the difference t5-τ1 between timing τ1 when the position detection sensor 34 detects a position indication pattern and timing t5 when the position detection sensor 34 detects the leading end of a sheet. In this manner, the leading end of a toner image can be aligned with a sheet by adjusting, on the basis of detection by the sensor 34, the sheet conveying velocity while the sheet is decelerated from the conveying velocity V0 to the conveying velocity V1.

At sheet leading end passing time t5, the CPU 201 decelerates the pair of registration rollers 31 to the sheet conveying velocity V′. Further, the CPU 201 decelerates driving of the pair of registration rollers 31 to the conveying velocity V1 when the sheet is conveyed by the distance L′0. The sheet conveyance distance can be measured by, e.g., counting, from timing t5 serving as a base point, the number of driving pulses of the roller driving motor 35 for driving the registration rollers. When the number of pulses corresponding to the distance L′0 is counted, the sheet conveying velocity is decreased to V1.

As described above, a single sensor can detect a position indication pattern and sheet leading end to prevent the positional discrepancy of an image caused by changes or variations in positions where the positions of the position indication pattern and sheet leading end are detected. This arrangement can decrease the number of sensors and downsize the apparatus. Since the number of components decreases, the apparatus can be manufactured at low cost, and the causes of failures can be decreased.

In a color printer, only a position indication pattern in a specific color among position indication patterns formed in respective color components is exploited for alignment in the first embodiment, i.e., alignment between a sheet and a toner image on the intermediate transfer belt. Position indication patterns in the remaining colors are exploited for alignment between toner images in the respective colors.

[Modification 2]

The first embodiment has described the position detection sensor 34 as a detection unit for an image position and sheet position. The position detection sensor 34 is also available as a density detection sensor which detects the density of a toner patch image formed on the intermediate transfer belt 40. The position detection sensor 34 performs feedback control to detect the toner density of a normal-density patch image formed on the intermediate transfer belt 40 and change image forming conditions. When successively forming images, the position detection sensor 34 can adjust the transfer conditions of the secondary transfer rollers 43 and 44 for each toner image on the basis of the density detection result of the normal-density patch, so as to stabilize the image density on a sheet.

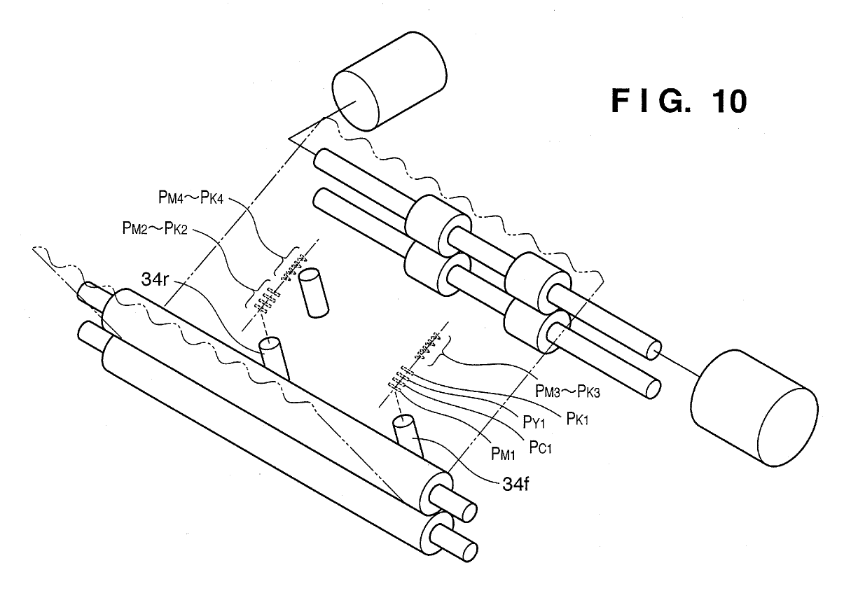

As shown in FIG. 10, the image forming stations 90, 96, 97, and 98 for respective color components form two sets of position indication patterns PM1, PC1, PY1, and PK1, and PM2, PC2, PY2, and PK2 on the intermediate transfer belt 40. The position detection sensors 34f and 34r detect these position indication patterns. As a result, the position and tilt of an image in the conveyance direction can be detected. Similarly, the position detection sensors 34f and 34r detect two sets of position indication patterns PM3, PC3, PY3, and PK3, and PM4, PC4, PY4, and PK4 formed by the image forming stations 90, 96, 97, and 98. Thus, the position of an image in the main scanning direction and the image magnification in the main scanning direction can be detected. Based on these detection results, image write positions by the four image forming stations 90, 96, 97, and 98 can be corrected to form a high-quality image free from any color discrepancy.

As described above, this modification adopts a sensor arrangement to detect the positions of a position indication pattern and sheet by a single sensor and single sensor unit. Image position correction control is executed to correct the positional discrepancy between a sheet and an image. Even if the sheet jam process is performed as shown in FIG. 2, the relative positions of sensors do not vary. This can abruptly increase the positional precision of an image on a sheet. Moreover, upsizing of the apparatus due to the position detection sensor arrangement and the use of a plurality of sensors can be prevented to downsize the overall apparatus.

[Modification 3]

This modification dose not use the reference voltage of the sensor 34. More specifically, the sensor 34 has a simpler arrangement by excluding, from the arrangement in FIG. 3, the light-receiving portion 34-2 for outputting a reference signal. The CPU 201 uses, as the reflectance, not the ratio between a detection signal and a reference signal, but the detection signal itself. The arrangement of this modification can further simplify the apparatus as long as the light-emitting portion is protected from contamination and the light quantity does not vary over time.

### Second Embodiment

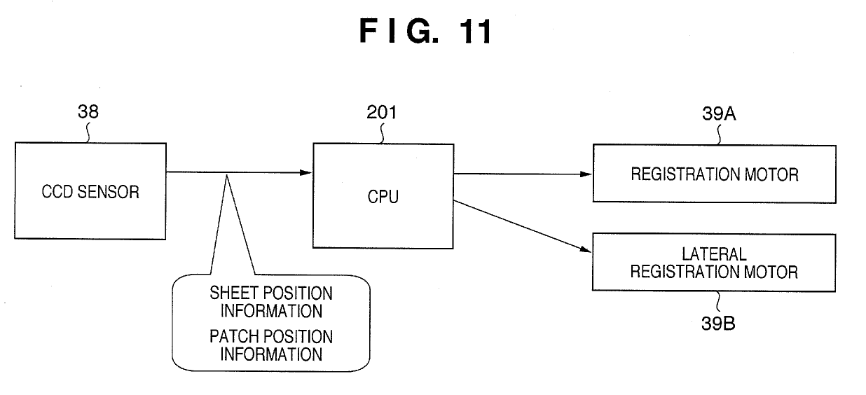

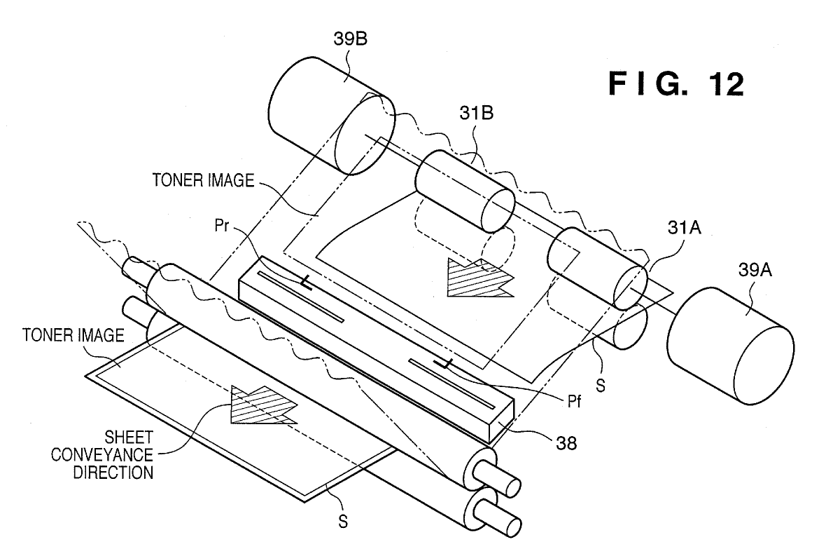

In the first embodiment, the roller driving motor 35 and lateral registration motor 37 correct a sheet position on the basis of the detection results of the position detection sensors 34f and 34r and lateral reference sensor 36 so that the sheet position and image position coincide with each other in the sheet conveyance direction and main scanning direction. In the second embodiment, the sheet position and image position in the sheet conveyance direction and main scanning direction can be corrected by an arrangement shown in the block diagram of FIG. 11 and the schematic view of FIG. 12.

The registration roller is divided into a pair of registration rollers 31A and a pair of registration rollers 31B. Registration roller driving motors 39A and 39B capable of independently freely controlling the number of revolutions drive the pairs of registration rollers 31A and 31B. A CCD sensor (or CIS sensor) 38 for detecting a position indication pattern and sheet is attached downstream of the registration rollers. As shown in FIG. 12, the CCD sensor 38 detects two position indication patterns Pf and Pr on the near and far sides. Further, the CCD sensor 38 detects the edge of a sheet. The CCD sensor 38 can, therefore, detect the tilt of a sheet, its position in the main scanning direction, and a positional discrepancy from a toner image in the conveyance direction. Based on these detection results, the registration roller driving motors 39A and 39B are controlled to correct the positional discrepancy between a sheet and an image.

For example, skew correction for a sheet and image is executed by setting a velocity difference (conveyance distance difference) between the registration roller driving motors 39A and 39B. A sheet skew can be detected as the difference between timings when the CCD sensor 38 detects the two corners of a sheet at the leading end. The detection timing difference is converted into the distance difference ΔL. Letting ΔV be the velocity difference between sheet conveying velocities by the registration roller driving motors 39A and 39B, the registration roller driving motors 39A and 39B are driven by the time t which satisfies ΔL=ΔV×t. Correction must be complete before a sheet reaches the transfer unit, so the time t has an upper limit. Thus, ΔV may be determined to satisfy ΔL=ΔV×t as the time before the leading end of a sheet reaches the transfer position after detected by the CCD sensor 38.

The positions of a sheet and image in the main scanning direction are corrected by temporarily skewing the sheet by a discrepancy amount by the registration roller driving motors 39A and 39B, and then conveying it straight. In this case, control is divided into the following phases (1) to (4).

(1) The velocities of the roller driving motors 39A and 39B are made different. A motor on a side opposite to one on which a sheet is to be skewed is driven faster.

(2) After the sheet skews, the roller driving motors 39A and 39B are driven at the same velocity.

(3) Upon the lapse of the time calculated from the correction amount and sheet conveying velocity in the main scanning direction, the velocities of the roller driving motors 39A and 39B are made different again. The velocity difference is set reversely to step (1).

(4) Upon the lapse of the same driving time as that in step (1), the roller driving motors 39A and 39B are driven at the same velocity. Accordingly, the sheet has move by a desired distance in the main scanning direction.

At this time, the velocity difference in phase (1), the time for driving with the velocity difference, and the driving time in phase (2) must be determined. The velocity difference and driving time in phase (3) can have the same values as those in phase (1) except that the motors are replaced. The time capable of correction is limited to the time until the leading end of a sheet reaches the transfer position after detected by the CCD sensor 38, similar to the above-described skew correction. Time parameters, i.e., time ta for driving with a velocity difference in phase (1) and driving time tb in phase (2) are determined in advance. After that, only the moving amount by which the motors are driven with the velocity difference is determined in accordance with the moving amount in the sub-scanning direction. For example, Lr represents the distance between the centers of the registration rollers 31A and 31B. Upon driving with the velocity difference Δv for the time ta, the driving distance is Δv*ta. This distance is the difference between distances by which the registration rollers 31A and 31B convey a sheet. Letting θ be the angle by which a sheet skews in an original conveyance direction, tan θ=(Δv*ta)/Lr, i.e., Δv=Lr*tan θ/ta. The moving distance Lm in the main scanning direction when conveying a sheet in the direction θ at a constant velocity V for the time tb is given by sin θ=Lm/(V*tb). The sensor detects Lm as a correction amount. Since θ=arcsin(Lm/(V*tb)), the velocity difference Δv is given by Δv=Lr*tan(arcsin(Lm/(V*tb)))/ta. The velocity difference Δv is the velocity difference between the roller driving motors 39A and 39B in phases (1) and (3).

In this control, position correction in the main scanning direction may cause the positional discrepancy between a sheet and a toner image in the conveyance direction. It is, therefore, desirable not to change the sheet velocity in the conveyance direction. Letting Vc be the velocity in the conveyance direction, the velocity V in skew is determined to satisfy cos θ=Vc/V. That is, Δv and V are decided from the above-described equations.

Finally, the positions of a sheet and image in the conveyance direction are corrected by adjusting the conveying velocities of the roller driving motors 39A and 39B. Because of correction in the conveyance direction, the two motors are driven at the same velocity. The correction method can be implemented by the same procedures as those described in the first embodiment.

In the second embodiment, a sheet skews due to the velocity difference between the registration rollers 31A and 31B. This may influence a velocity for the sheet conveyance direction component. Position correction in the conveyance direction must consider even deviation under this influence. Assume that the above-described control to make the velocity constant in the conveyance direction during skew correction (period during which the velocities of the registration rollers 31A and 31B are made different) is not executed. In this case, the velocity Vc in the conveyance direction during skew correction is Vc=V*cos θ. If the conveying velocity V is constant regardless of whether skew correction is in progress, the skew correction time is tb, and the conveyance distance during skew correction is Vc*tb=(V*cos θ)*tb. If no sheet skews, the distance during skew correction is V*tb, and the difference is V*tb*(1−cos θ). The time difference (sheet delay) when the sheet is conveyed at the velocity V is tb*(1−cos θ). The time tb*(1−cos θ) is added to the detection time difference (t5-τ1) between the sheet leading end position and the position indication pattern by the position detection sensor. The sum is used instead of the detection time difference (t5-τ1), and correction control is performed similarly to the first embodiment.

This arrangement can abruptly increase the positional precision of an image on a sheet. At the same time, this arrangement can prevent upsizing of the apparatus to downsize the overall apparatus.

### Third Embodiment

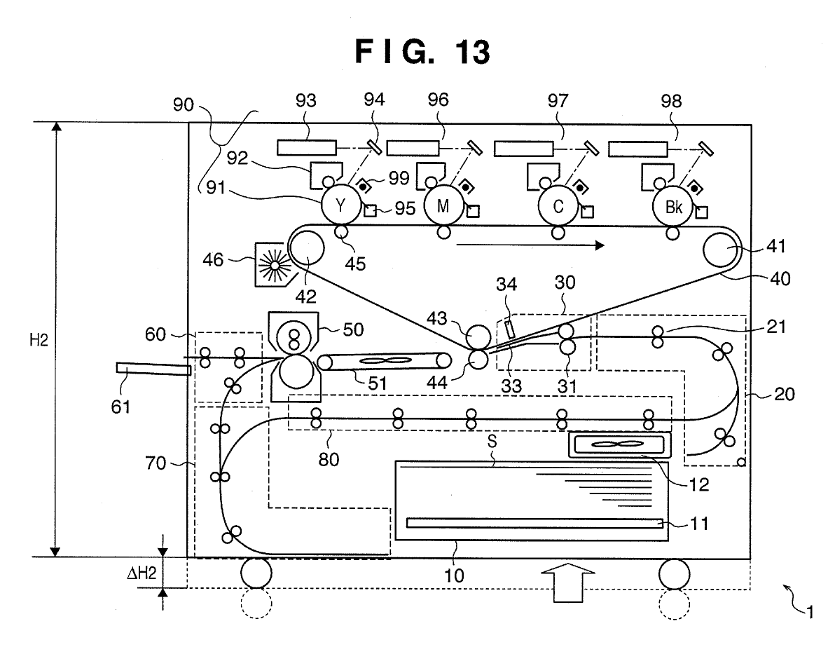

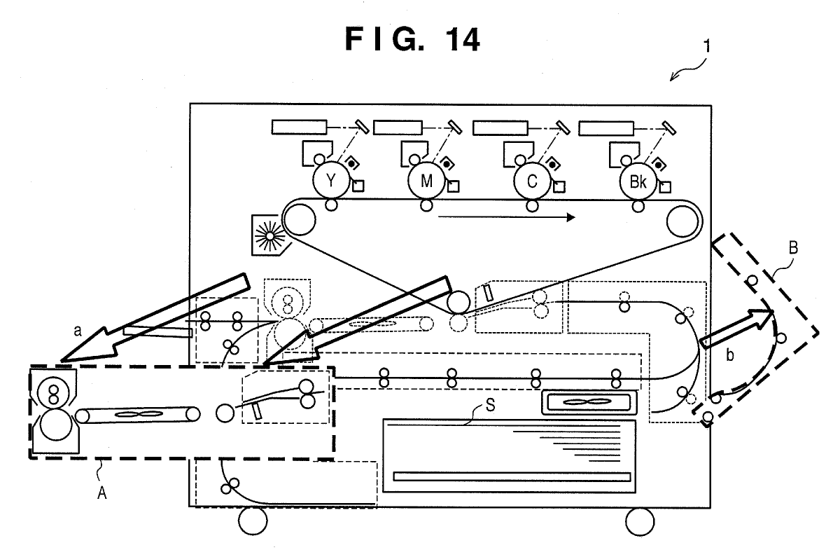

FIG. 13 is a sectional view showing the schematic structure of a copying machine and printer according to the third embodiment. The third embodiment is different from the first and second embodiments in that an intermediate transfer belt 40 is transparent or semitransparent, and a position detection sensor 34 is arranged inside the intermediate transfer belt 40. FIG. 14 is a schematic view showing a jam process method. Also in FIG. 14, only the arrangement of the position detection sensor 34 is different. The remaining arrangement is the same as those in the first and second embodiments, and a description thereof will not be repeated.

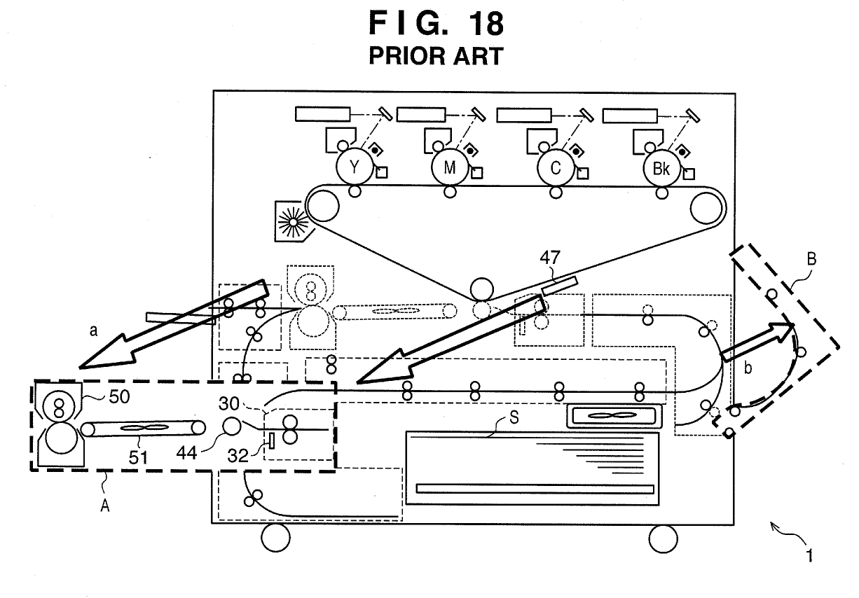

In the third embodiment, a pre-transfer guide 33 need not be arranged while detouring around the position detection sensor 34 within the height H0 of the conventional copying machine and printer shown in FIGS. 17 and 18. Thus, the height of the printer according to the third embodiment can be decreased to H2 smaller than H0 by ΔH2. Compared to the first and second embodiments, the apparatus can be further downsized because the position detection sensor 34 is arranged inside the intermediate transfer belt 40.

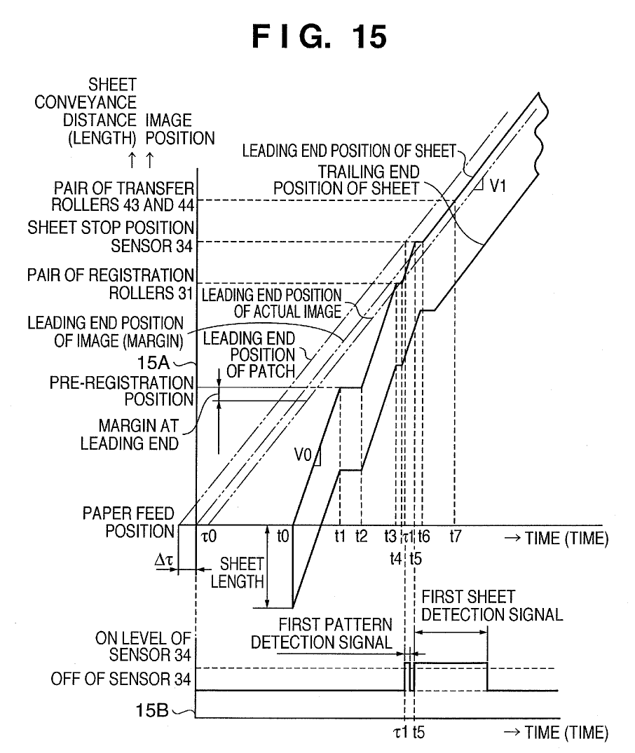

The operation of a registration unit 30 will be explained in detail with reference to diagrams 15A and 15B of FIG. 15. In the third embodiment, steps (1) to (6) and (9) are the same as those in the first embodiment, and a description thereof will not be repeated.

Immediately when the position detection sensor 34 detects the position of a sheet conveyed at the conveying velocity V0, the sheet stops. At time t6 upon the lapse of a predetermined time after position indication pattern detection time τ1, a pair of registration rollers 31 restarts at the transfer velocity V1. A lateral registration motor 37 in a registration roller sliding unit is driven to correct the position in the lateral direction on the basis of the lateral position detection result of the position indication pattern by the position detection sensor 34 and the lateral position detection result of the sheet by a lateral reference sensor 36.

Similar to the first and second embodiments, this arrangement can abruptly increase the positional precision of an image on a sheet. At the same time, this arrangement can prevent upsizing of the apparatus to downsize the overall apparatus.

As described above, according to the first to third embodiments, a single sensor and single sensor unit are used to detect the position of a position indication pattern, that of a sheet, a patch density, and the position of a color discrepancy correction patch. The apparatus can be simplified in comparison with the use of sensors for respective purposes. Since no sheet conveying unit need be arranged while detouring around the position detection sensor, the overall apparatus can be downsized.

Even when a sheet jams and the sheet jam process is executed by extracting the registration unit 30, secondary outer transfer roller 44, and conveyance belt 51 from the apparatus, the detection precision does not change from that before the process.

The first to third embodiments have described an arrangement using the intermediate transfer belt 40, but the present invention is not limited to the intermediate transfer belt. The present invention may be applied to an intermediate transfer drum, photosensitive drum, photosensitive belt, or the like. Even in this case, the same effects can be obtained as long as a single sensor and single sensor unit detect the positions of a position indication pattern and sheet to perform image position correction control to correct the positional discrepancy between the sheet and the image. In the first to third embodiments, the sensor detects the toner patch P. Alternatively, the sensor may directly detect a toner image.

The present invention may be applied to a system including a plurality of devices (e.g., a host computer, interface device, reader, and printer) or an apparatus (e.g., a copying machine or facsimile apparatus) formed by a single device. The object of the present invention is also achieved by supplying a storage medium which stores program codes for implementing the functions of the above-described embodiments to a system or apparatus, and reading out and executing the program codes stored in the storage medium by the computer of the system or apparatus. In this case, the program codes read out from the storage medium implement the functions of the above-described embodiments, and the program codes and the storage medium storing the program codes constitute the present invention.

The present invention is applicable to a case where an OS (Operating System) or the like running on the computer performs some or all of actual processes on the basis of the instructions of the program codes and thereby implements the functions of the above-described embodiments. The present invention is also applicable to a case where the program codes read out from the storage medium are written in the memory of a function expansion card inserted into the computer or the memory of a function expansion unit connected to the computer. In this case, the CPU of the function expansion card or function expansion unit performs some or all of actual processes on the basis of the instructions of the program codes, and thereby implements the functions of the above-described embodiments.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application Nos. 2006-220635, filed Aug. 11, 2006, and 2007-146107 filed on May 31, 2007, which are hereby incorporated by reference herein in their entirety.

What is claimed is:

1. An image forming apparatus which forms a toner image on a sheet, comprising:
a forming unit which forms a toner image on a movable image carrier;
a transfer unit which transfers the toner image formed on the image carrier onto a sheet at a transfer position;
a sheet conveying unit which conveys the sheet so as to pass through the transfer position;
a sensor which is arranged upstream of the transfer position and detects the sheet conveyed by the sheet conveying unit and the toner image formed on the image carrier or a position reference image; and
a control unit which controls conveyance of the sheet by the sheet conveying unit based on detection by the sensor so as to synchronize the sheet conveyed by the sheet conveying unit with the toner image formed on the image carrier.

2. The apparatus according to claim 1, wherein
a moving velocity of the image carrier and a conveying velocity of the sheet conveyed by the sheet conveying unit are different velocities, and
the control unit controls conveyance of the sheet by adjusting, based on detection by the sensor, conveyance time of the sheet by the sheet conveying unit while the conveying velocity of the sheet decreases to a moving velocity of the toner image.

3. The apparatus according to claim 1, wherein
a moving velocity of the image carrier and a conveying velocity of the sheet conveyed by the sheet conveying unit are different velocities, and
the control unit controls conveyance of the sheet by adjusting, based on detection by the sensor, the conveying velocity of the sheet by the sheet conveying unit while the conveying velocity of the sheet decreases to a moving velocity of the toner image.

4. The apparatus according to claim 1, wherein the position reference image is a toner patch formed on the image carrier prior to the toner image to be transferred onto the sheet, the sensor detects the toner patch and a leading end position of the sheet conveyed by the sheet conveying unit, and the control unit aligns the sheet with the toner image formed on the image carrier based on detection by the sensor.

5. The apparatus according to claim 1, further comprising:
a lateral position detection unit which detects a position of a sheet in a lateral direction perpendicular to a conveyance direction of the sheet; and
a lateral adjustment unit which adjusts the position of the sheet based on the position in the lateral direction detected by the lateral position detection unit so as to align the sheet with the toner image in the lateral direction.

6. The apparatus according to claim 1, wherein the image carrier comprises a transfer belt.

7. The apparatus according to claim 6, wherein the sensor comprises:
a light-emitting element configured to emit light toward the transfer belt;
a partially reflecting surface configured to partially reflect light emitted by the light-emitting element;
a first light-receiving element configured to receive light reflected by the partially reflecting surface and generate a first output signal corresponding to an intensity of the light received by the first light-receiving element; and
a second light-receiving element configured to receive light which passes through the partially reflecting surface and is reflected by one or more of the transfer belt, the toner image or the position reference image formed on the transfer belt and the sheet and generate a second output signal corresponding to an intensity of the light received by the second light-receiving element.

8. The apparatus according to claim 7, wherein the control unit is configured to control conveyance of the sheet by the sheet conveying unit based on the first output signal and the second output signal generated by the sensor.

9. A position detection sensor for use in an image forming apparatus which forms a toner image on a movable image carrier and transfer the toner image formed on the image carrier onto a sheet at a transfer position, the position detection sensor comprising:
a light-emitting element configured to emit light toward the image carrier;
a partially reflecting surface configured to partially reflect light emitted by the light-emitting element;
a first light-receiving element configured to receive light reflected by the partially reflecting surface and generate a first output signal corresponding to an intensity of the light received by the first light-receiving element; and
a second light-receiving element configured to receive light which passes through the partially reflecting surface and is reflected by one or more of the image carrier, a toner patch formed on the image carrier and the sheet and generate a second output signal corresponding to an intensity of the light received by the second light-receiving element.

10. The position detection sensor according to claim 9, wherein the light-emitting element, the partially reflecting surface, the first light-receiving element and the second light-receiving element are integrated into a single inseparable component.

11. An image forming apparatus comprising:
the position detection sensor according to claim 9;
a forming unit which forms a toner image on a movable image carrier;
a transfer unit which transfers the toner image formed on the image carrier onto a sheet at a transfer position;
a sheet conveying unit which conveys the sheet so as to pass through the transfer position;
a control unit which controls conveyance of the sheet by the sheet conveying unit based the first output signal and the second output signal generated by the position detection sensor so as to synchronize the sheet conveyed by the sheet conveying unit with the toner image formed on the image carrier.

12. The image forming apparatus according to claim 11, wherein the image carrier comprises a transfer belt.

13. A method for use in an image forming apparatus which forms a toner image on a movable image carrier and transfer the toner image formed on the image carrier onto a sheet at a transfer position, the method comprising:
emitting light toward the image carrier;
using a partially reflecting surface to partially reflect the emitted light;
receiving light reflected by the partially reflecting surface and generating a first output signal corresponding to an intensity of the received light;
receiving light which passes through the partially reflecting surface and is reflected by one or more of the image carrier, a toner patch formed on the image carrier and the sheet and generating a second output signal corresponding to an intensity of the received light; and
controlling conveyance of the sheet based on the first output signal and the second output signal so as to synchronize the sheet with the toner image formed on the image carrier.

14. The method according to claim 13, wherein the emitting light toward the image carrier and the receiving light reflected by the partially reflecting surface and the receiving light which passes through the partially reflecting surface are performed by a single inseparable component.
